(19) United States
(12) Patent Application Publication
(10) Pub. No.: US 2019/0099971 A1
(43) Pub. Date: Apr. 4, 2019

(54) MANUALLY OPERATED ENCLOSED HARD DISK DESTRUCTION APPARATUS

(71) Applicants: Kevin GUTIERREZ, Chatsworth, CA (US); Michael Forman, Chatsworth, CA (US); Perry Solomon, Chatsworth, CA (US)

(72) Inventors: Kevin GUTIERREZ, Chatsworth, CA (US); Michael Forman, Chatsworth, CA (US); Perry Solomon, Chatsworth, CA (US)

(21) Appl. No.: 16/144,065

(22) Filed: Sep. 27, 2018

Related U.S. Application Data
(60) Provisional application No. 62/565,854, filed on Sep. 29, 2017.

(51) Int. Cl. B30B 1/32; B30B 15/06

(52) U.S. Cl. CPC B30B 1/326; B30B 15/065

(57) ABSTRACT

Devices, methods, and systems are described for memory destruction device (MDD) for a hard disk drive or a solid state drive. In an embodiment, the MMD includes only mechanical components. In one embodiment, the MMD may destroy one or more HDDs or SSDs at a time.

This application claims priority to U.S. Provisional Application No. 62/565,854, which is incorporated herein in its entirety.

### BACKGROUND OF THE INVENTION

### 1. Field of the Invention

The present invention generally relates to the destruction of electrical or computer components, and more particularly, to the destruction of memory devices, such as hard drives, solid state drives, and other memory devices that store data.

### 2. Background

An increasingly important topic is that of data security and privacy. In many cases, a person or entities identification information including names, addresses, login information, bank account information, and payment information are stored electronically on a computer-based device, such as a laptop, mobile device, desktop computer, tablet, and the like. Some of this information may be confidential or otherwise sensitive. Each of these devices stores data representative of the identification information in a memory.

One of the common methods for a data security breach includes the removing of such data from failed and/or discarded memory devices. In many cases, erasing the data is not sufficient to completely remove such data, Accordingly, adequate destruction of such memory devices with such data requires physical destruction.

There are several methods to accomplish the physical destruction of hard disk drives including shredding or outsourcing the destruction to third parties. These methods may be cost ineffective, difficult to operate, and require use of significant amounts of power.

Therefore, a need for an economically viable option to protect against the extraction of potentially compromising data from hard disk drives which is safe, easy to operate, and does not require an electrical power source.

### BRIEF DESCRIPTION OF THE DRAWINGS

The advantages of the invention and preferred embodiments are more fully understood by referencing the following detailed descriptions of the drawings.

FIG. 1 is a front view of the present invention in an embodiment

FIG. 2 is a front view of the present invention with its door open to restrict operation in an embodiment.

FIG. 3 is a front view of the present invention without its enclosure in an embodiment.

FIG. 4 is an isolated front view of the hard disk drive base loaded with two 2.5-inch hard disk drives in an embodiment.

FIG. 5 is an isolated front view of the hard disk drive base loaded with two 3.5-inch hard disk drives in an embodiment.

FIG. 6 is an isolated isometric view of the anvil with relevant dimension callouts in an embodiment.

FIG. 7 is a flow chart in an embodiment for the destruction of a hard drive.

FIG. 8 is a front view of the present invention with the anvil lowered to contact two 3.5-inch hard disk drives during operation embodiment.

FIG. 9 is an illustration demonstrating a hard disk drive being permanently disabled by the present invention embodiment.

FIG. 10 is an isometric view of the anvil detached from the hydraulic arm embodiment.

### DETAILED DESCRIPTION

Each of the additional features and teachings disclosed below can be utilized separately or in conjunction with other features and teachings to provide a device, system, and/or method for a memory destruction device (MDD) for destruction of memory devices, such as hard disk drives (HDD) or solid state drives (SSD). Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

In one embodiment, the MDD may permanently physically disable one or more HHDs or SSDs to prevent data extraction. Data includes any information in computer code that may be stored on a memory device. In one embodiment, the MDD may operate without a power source. In one embodiment, the MDD may operate with a wired or wireless power source. In one embodiment, the MDD may include only mechanical components.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

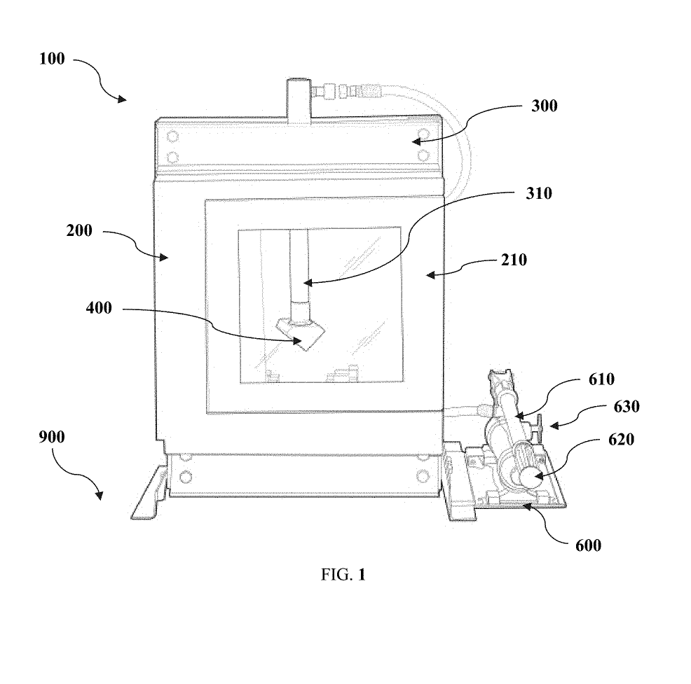

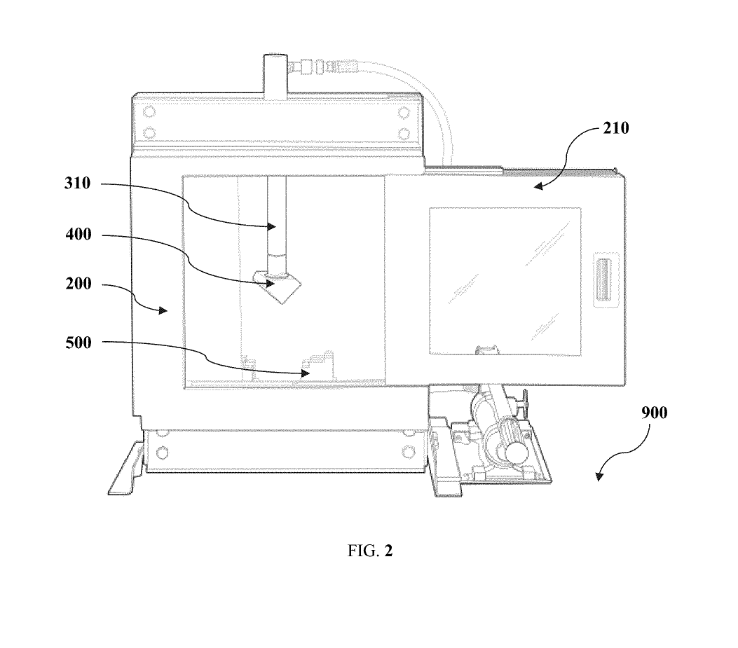

FIGS. 1 and 2 depict a MDD 100 in an embodiment and includes an enclosure 200. As shown in FIG. 2, a built-in safety feature of the MDD 100 may be included such that the hydraulic pump 600 may not be operated when the enclosure door 210 is open. In another embodiment, the enclosure door 210 may not be open if the hydraulic arm 610 is not horizontal or resting on the hydraulic pump 600.

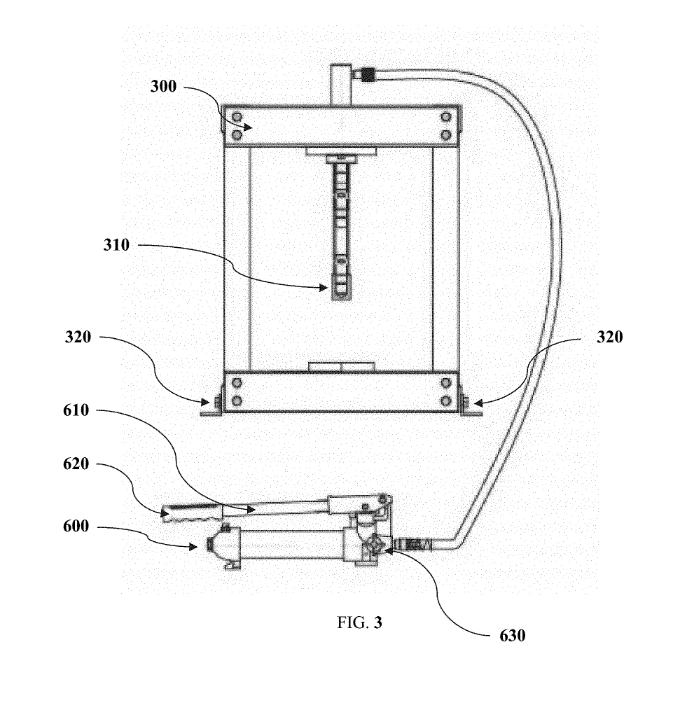

FIG. 3 depicts the MDD 100 including a bench press 300, anvil 400, hard disk drive base 500, and hydraulic pump 600. The base 500 may also be configured for a SSD. In other embodiments, The MDD 100 may include other components, such as a bottle jack or gear system. In some embodiments, the MDD 100 may be formed from steel or other similar metal. During operation, the hydraulic pump 600 may be used to lower the anvil 400 with a force. In some embodiments, the amount of force may be approximately up to four tons or more of force, The anvil 400 may make contact with hard disk drive(s) 700 secured onto the hard disk drive base 500. As the anvil 400 continues to lower, the hard disk drive chassis 710 will crack and the magnetic platter(s) 720 will be permanently deformed, permanently disabling the hard disk drive and making the data stored or once stored on the drive unrecoverable.

As shown in FIGS. 1-2, the MDD 100 includes an enclosure 200 which closes off the internal components of the apparatus 100 during operation. The enclosure 200 may include a sliding door 210 equipped with a transparent section to allow the user to observe the internal components of the apparatus 100 during operation. In one embodiment, the sliding door 210 also acts as a safety feature because the door can only be opened when the hydraulic arm 610 is at a horizontal position or resting directly on the hydraulic pump 600. Additionally, the hydraulic arm 610 cannot be operated while the sliding door 210 is open.

In one embodiment, the hydraulic arm 310 and anvil 400 may remain stationary whenever the sliding door 210 is open. This protects from any potential injuries that may occur from the anvil being allowed to move freely while the sliding door 210 is open and anything other than a hard disk drive 700 is in its path.

When the sliding door 210 is closed and the apparatus 100 is in operation, the enclosure 200 protects the user from any potential hazards due to the destructive nature of the apparatus 100. This includes debris and projectiles resulting from the destruction of the hard disk drive(s) 700 that are particulate or more substantial in nature which would otherwise become an immediate hazard if not contained.

FIG. 3 shows the internal components of the apparatus 100 once the enclosure has been removed. The bench press 300 provides a sturdy frame capable of withstanding the large forces required to physically disable a hard disk drive 700. A hydraulic pump 600 serves to create a mechanical advantage capable of generating the force required for the anvil 400 to permanently deform and disable the hard disk drive(s) 700 using only the mechanical force input by an average user using hydraulic arm 610. The mechanical force input by the user is maximized using the moment arm of the hydraulic arm 610 and is increased further in the hydraulic pump 600 which is filled with hydraulic fluid. This relies on concepts from fluid dynamics and pressure difference to convert the small input force generated. The hydraulic arm 610 is capped with handle grip 620 for user ergonomics.

During operation, the hydraulic arm 610 is raised to its maximum extension, then lowered to its lowest point or until necessary to disable the hard disk drive(s) 700. The rotational movement in the downwards direction of the hydraulic arm 610 may result in a downwards movement of the hydraulic arm 310.

This process of raising and lowering the hydraulic arm 610 may have to be conducted one or more times depending on the initial vertical position of the hydraulic arm 310. The process of lowering the hydraulic arm 310 from its fully retracted position to allow the anvil 400 to destroy one or more hard disk drives 700 may be achieved in, for example, under one minute by the average user.

The MDD 100 is stable in due to its weight distribution and center of gravity. The apparatus 100 may remain stationary and almost all dynamic and static forces act exclusively in the vertical axis. The bench press 300 comes equipped with side brackets 320 which provide additional stability to the structure throughout its lifetime. The side brackets 320 provide the apparatus with a larger footprint and contact area which both help with weight and mechanical force distribution with the stationary surface 900 on which it is resting.

In one embodiment, to provide the option for increased stability, the side brackets 320 may have openings to allow the apparatus 100 to be bolted or secured directly to a stationary location such as a workbench or tabletop 900.

One advantage of utilizing a bench press 300 which may only utilize mechanical components to destruct one or more hard disk drives 700 is the need for no electrical components, such as a power source. Additionally, the absence of an electrical component simplifies the apparatus 100, offering superior longevity potential. The lack of an electrical component also minimizes long-term capital investment by eliminating future payments required for electrical resources.

The anvil 400 utilized to carry out the destruction of one or more hard disk drives 700 in one instance has a form resembling an extruded diamond-shaped cross-section. Due to this form, as the tip of the anvil 400 makes contact with the hard disk drive(s) 700 supported on the hard disk drive base 500 and continues to apply force to the hard disk drive(s) 700, a substantially uniformly distributed force is applied across a single rectangular area where tip of the anvil 400 comes into direct contact with the hard disk drive 700. This is shown visually in FIG. 8.

Because the hard disk drive(s) 700 are secured by the hard disk drive base 500, a stress concentration encompassing the area where the anvil 400 is in direct contact with the hard disk drive 700 forms. This results in the hard disk drive(s) 700 experiencing compression forces at their respective top surface and tension forces at heir respective bottom surface. This is also commonly referred to as bending stress.

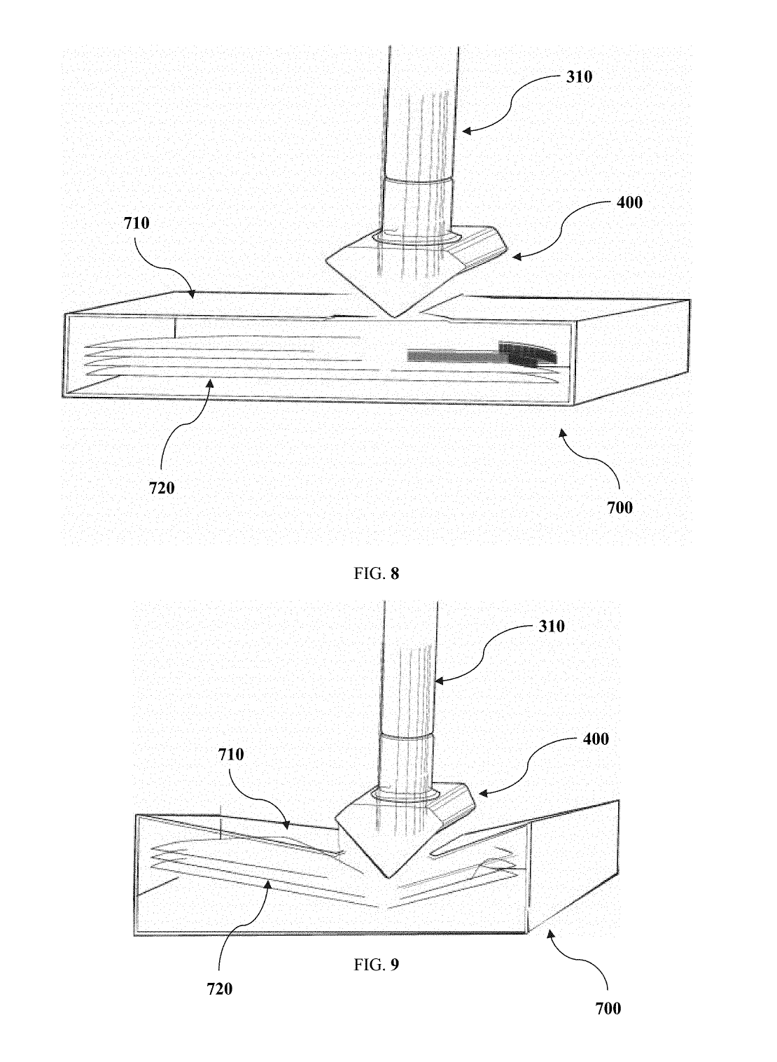

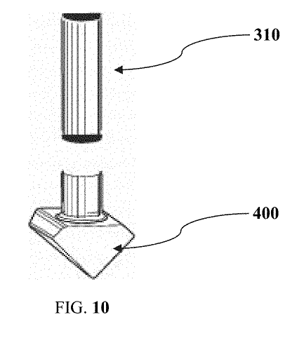

As mechanical energy continues to be distributed from the anvil 400 to the hard disk drive(s) 700, the hard disk drive(s) 700 give way and the chassis 710 is visibly dismantled. The destruction of the chassis 710 typically originates at the respective bottom surface of the hard disk drive(s) 700 and propagates to the top surface in a path centered vertically about the tip of the anvil 400. This process is illustrated in FIG. 9.

As mechanical energy continues to be distributed from the anvil 400 to the hard disk drive(s) 700 even further and the chassis 710 is compromised, the magnetic platter(s) 720 where data is stored or was once stored is permanently deformed. Once deformed, the hard disk drive(s) 700 can be considered permanently disabled and safe from future data extraction.

The form of the anvil 400 allows for the transfer of a large normally-distributed force over a small rectangular area along the center of two 2.5-inch or two 3.5-inch hard disk drives 700. Other size HDDs or SSDs may be destructed using the MDD.

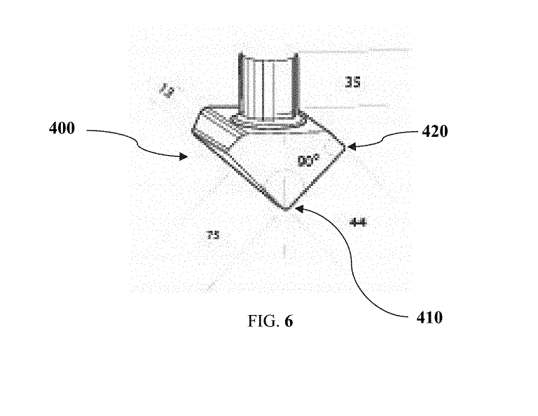

FIG. 6 shows a detailed view of the anvil 400 with dimension callouts. An approximately 90-degree angle is formed between the two surfaces which connect to form the penetrating tip 410 of the anvil 400. This is done to create a cross-sectional shape of sufficient sharpness to easily initiate the deformation of the hard disk drive(s) 700 while maintaining a structural integrity that will lead to a longer tool life. The smaller the angle between the two surfaces, the more susceptible to wear the anvil 400 becomes while the larger the angle between the two surfaces the blunter the penetrating tip 410 becomes. The 90-degree angle currently utilized offers a balance between tool sharpness and tool life.

The cross-section of the anvil 400 may be configured substantially in the shape of a diamond. Other shapes may include substantially excluded triangle, substantially pyramidal, or substantially cone. Its cross-section is symmetrical in nature. The two surfaces that meet to form the penetrating tip of the anvil 400 have a length of approximately 44 mm, respectively. The length may be approximately between 35-50 mm in some embodiments. The top surfaces which each form approximate 90-degree angles with the surfaces forming the tip 420 each have a length of approximately 13 mm. The length may be approximately between 10-20 mm in some embodiments. The anvil 400 has an extruded length of approximately 75 mm. This length is sufficient to make contact across a minimum of 74.5% of the width of both 2.5-inch and 3.5-inch hard disk drives 700. It should be noted that 2.5-inch hard disk drives 730 have nominal dimensions of 100.2×69.85 mm and 3.5-inch hard disk drives 740 have nominal dimensions of 147×101.6 mm. This extrusion width adequately distributes mechanical energy across the center of the hard disk drive(s) 700 and cause destruction through bending stress.

The anvil 400 may easily be mounted and removed from the hydraulic arm 310 to allow for adaptations and improvements, such as 2.5 inch SSD, mSATA SSD, M.2 SSD, PCI-express SSD, flash drives, flash memory, memory sticks, multimedia cards, and smart media. Other memory devices may also be included. In one embodiment, the anvil 400 may be held in place using the concept of a retaining ring.

FIG. 10 illustrates the separation of the hydraulic arm 310 and anvil 400, which create secure a connection between the two components when reconnected. The hydraulic arm 310 has a cavity in the shape of a hollow ring of minimal depth along the perimeter of its inside face. The anvil 400 has a substantially tubular section whose outer diameter substantially matches the inner diameter of the hydraulic arm 310.

The anvil 400 has an extruded ring on the outside face of its tubular section which substantially matches the existing cavity on the hydraulic arm 310. To mount to the anvil 400 to the hydraulic arm 310, the anvil 400 is aligned with the arm 310 and forced upwards with sufficient force to lodge the extrusion along the perimeter of the outer face of the anvil 400 with the cavity on the inner face of the hydraulic arm 310.

To remove the anvil 400 from the hydraulic arm 310, the anvil 400 is pulled downwards with sufficient force to dislodge the extruded retaining ring on the anvil 400 from the cavity on the hydraulic arm 310.

This ability to easily mount and remove the anvil 400 from the apparatus 100 allows for other configurations. For example, the destruction of SSDs differs from that of HDDs in that by nature SSDs do not have any internal moving components. In the case of SSDs, data is stored on flash memory arranged in a grid pattern. To ensure that the data in SSDs is rendered unrecoverable, all flash memory components must be disabled. The present invention 100 allows for the adaption of anvil 400 and base 500 which target these flash memory grids to prevent future data extraction.

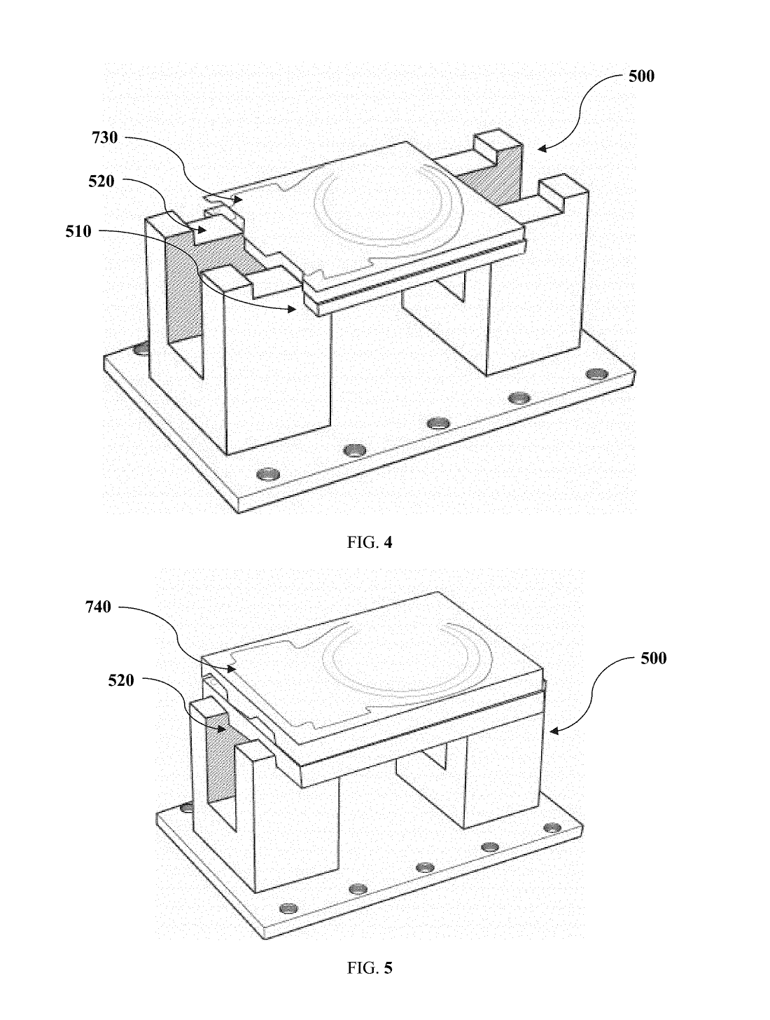

As shown in FIGS. 4-5, the hard disk drive base 500 is designed such that the base can accommodate up to two 2.5-inch hard disk drives 730 or two 3.5-inch hard disk drives 740 during a single operation. This is achieved through a design which incorporates individual steps for each type of hard disk drive 700. Additionally, the stepped hard disk drive base 500 has a slot or gap that runs between the two individual pieces horizontally. This feature reduces overall material required and in the process, reduces overall weight while maintaining the same effectiveness of a stepped design without the gap feature. The first step 510 is meant for 2.5-inch hard disk drives 730 and has a height of approximately 8 mm. The second step 520 is meant for 3.5-inch hard disk drives 740 and has a height of approximately 7.3 mm. This height ensures that two hard disk drives 700 can be stacked on top of one another while maintaining a fixed position during the destruction process. The base may have accommodate more than two HDDs or SDDs. In other embodiments, the base may have accommodate one or more HDDs or SDDs

During operation, the hard disk drive(s) 700 are rested on a total of four rectangular areas on the hard disk drive base 500. This support offers resistance at the outermost corners of the hard disk drive(s) 700. Because a substantially equally distributed force is being applied to the center of the hard disk drive(s) 700 a bending stress phenomena occurs which ultimately permanently disables the hard disk drive(s) 700.

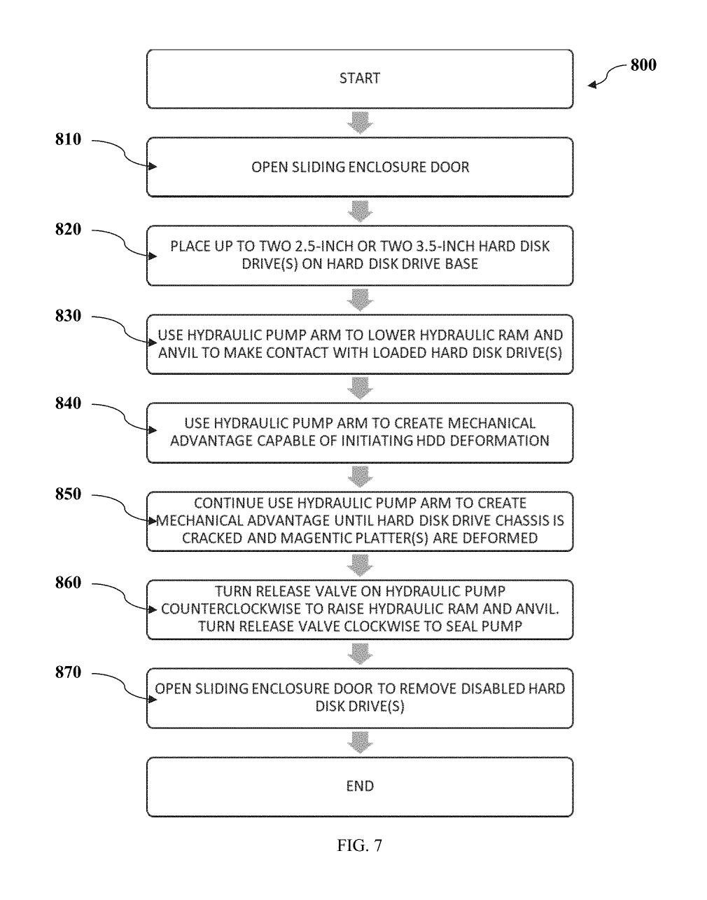

FIG 7. is a flow chart outlining the operation procedure for the apparatus 100. This procedure is initiated by opening the sliding enclosure door 810 to allow access to the internal structure of the apparatus 100. It should be noted that the sliding enclosure door 210 cannot be opened unless the hydraulic arm 610 is at a minimum of a horizontal position or is angled towards the ground. This is a safety feature to prevent access to the hydraulic pump 600 while the sliding enclosure door 210 is open and subsequently prevent movement of the hydraulic arm 310 and anvil 400. Due to this safety feature, there are no moving parts while the sliding enclosure door 210 is open, ensuring the safety of the user. During the next step 820 the apparatus 100 can be loaded with up to two 2.5-inch hard disk drives 730 or two 3.5-inch hard disk drives 740. This is achieved by stacking the hard disk drives 700 on the appropriate step on the hard disk drive base 500, taking precaution to center the hard disk drive(s) 700 about the center of the anvil 400. When mounted correctly, the hard disk drive(s) 700 will rest on a total of four rectangular areas on the hard disk drive base 500. Once the hard disk drive(s) 700 are properly mounted, the sliding enclosure door 210 should be closed.

This sliding door 210 seals off the internal structure of the apparatus 100 and protects the user from potential debris or projectiles originating from the destruction of the hard disk drive(s) 700. Again, the apparatus 100 cannot continue operation without first closing the sliding enclosure door 210.

The next step 830 is to use the hydraulic pump arm 610 to lower the hydraulic arm 310 and anvil 400 until the anvil makes contact with the top surface of the top hard disk drive 700. This is achieved by applying a rotational force upwards to the hydraulic arm 610 until the arm 610 reaches its maximum extension. The hydraulic arm 610 may be be lowered by applying a rotational force downwards. The resultant mechanical force input is transferred to the hydraulic pump 600 during this process, where a mechanical advantage is gained using hydraulic fluid and the concepts of fluid dynamics.

The mechanical force input into the hydraulic pump 600 is multiplied and transferred to the hydraulic arm 610 which lowers the anvil 400 to the desired position. This process of raising and lowering the hydraulic arm 610 may need to be repeated several times to adjust the anvil 400 to the appropriate position.

Once the anvil 400 has made contact with the hard disk drive 700 the hydraulic arm can be continued to be used to apply a mechanical force of up to approximately four tons or more to the hard disk drive(s) 700 during step 840, Other amounts of force are possible.

This applied mechanical force will cause the hard disk drive(s) 700 to experience a bending stress characterized by compression stress experienced at their respective top surface and tension stress experienced at the respective bottom surface. The hard disk drive(s) will begin to give way to the induced stress and a crack will initiate about the area where the anvil 400 is centered relative to the hard disk drive(s) 700. During, step 850 a mechanical force is continued to be applied through the hydraulic arm 610 that is transferred to the contact area between the anvil 400 and the hard disk drive(s) 710. The resultant destruction of the hard disk drive(s) 700 is characterized by the hard disk drive chassis 710 being cracked and the magnetic platter 720 being permanently deformed, Since the data is stored or was once stored on the magnetic platter(s) 720, the hard disk drive(s) 700 is essentially rendered permanently disabled.

Data potentially stored on the magnetic platter(s) 720 is not wiped, but rather, the deformation of the magnetic platter(s) 720 effectively prevents future use of magnetic read heads to retrieve data from the disabled hard disk drive(s) 700. Additionally, the, physical damage imparted onto the hard disk drive(s) 700 prevents future interface with computer or data reading components which would otherwise connect and operate directly with the hard disk drive(s) 700.

Once the hard disk drive(s) 700 have been disabled, the hydraulic arm 310 and anvil 400 can be raised using the release valve 630 located on the hydraulic pump 600 during step 860. To raise the hydraulic arm 310 and anvil 400, the release valve 620 must be turned counterclockwise. The longer the time span between when the release valve 620 is opened, the further up the hydraulic arm 310 will travel. To stop the movement of the hydraulic arm 310, the release valve 630 must be turned clockwise until properly sealed.

This step must be taken prior to continuing with the operation procedure to ensure that the hydraulic arm 310 and anvil 400 remain stationary when not in operation. During the final step 870, the sliding enclosure door 210 can be opened to remove the disabled hard disk drive(s) 700. It should be noted once again that the sliding enclosure door 210 cannot be opened unless the hydraulic arm 610 is at a horizontal position or is resting on the hydraulic pump 600. This feature was enforced with the safety of the user in mind. Once retrieved, the disabled hard disk drive(s) can subsequently be discarded as desired.

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be, apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . .”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A memory destruction device (MDD), comprising
a base for receiving one or more disks;
a hydraulic arm having a arm; and
an anvil coupled to the arm to apply mechanical pressure to the one or disks to destroy the one or more disks when pressure is applied to lower the hydraulic arm.

2. The MDD of claim 1 further comprising a release valve to raise the hydraulic arm

3. The MDD of claim 1 wherein the one or more disks comprise a hard disk drive (HDD), 2.5 inch Solid State Device (SSD), mSATA SSD, M.2 SSD, PCI-express SSD, flash drives, flash memory, memory sticks, multimedia cards, or smart media.

4. The MDD of claim 1 further comprising a hydraulic pump coupled to the hydraulic arm.

5. The MDD of claim 1 further comprising a sliding door with a transparent section.

6. The MDD of claim 1 wherein the hydraulic arm applies a force up to four tons.

7. The MDD of claim 1 wherein the anvil has symmetrical cross-section.

8. The MDD of claim 1 wherein the anvil has a diamond-shaped, substantially excluded triangle, substantially pyramidal, or substantially cone cross section.

9. The MDD of claim 1 wherein the arm is coupled to the anvil with a retaining ring.

10. The MDD of claim 1 wherein the base has more than one shelf to receive the one or more disks.

11. A method for destroying a disk having a memory, comprising:
providing a a base for receiving one or more disks;
lowering a hydraulic arm having a arm to enable an anvil coupled to the arm to apply mechanical pressure to the one or disks to destroy the one or more disks.

12. The method of claim 11 further comprising providing a release valve to raise the hydraulic arm

13. The method of claim 11 wherein the one or more disks comprise a hard disk drive (HDD), 2.5 inch Solid State Device (SSD), mSATA SSD, M.2 SSD, PCI-express SSD, flash drives, flash memory, memory sticks, multimedia cards, or smart media.

14. The method of claim 11 further comprising a hydraulic pump coupled to the hydraulic arm.

15. The method of claim 11 further comprising a sliding door with a transparent section.

16. The method of claim 11 further comprising applying a force up to four tons with the hydraulic arm.

17. The method of claim 11 wherein the anvil has symmetrical cross-section.

18. The method of claim 11 wherein the anvil has a diamond-shaped, substantially excluded triangle, substantially pyramidal, or substantially cone cross section.

19. The method of claim 11 further comprising coupling the arm to the anvil with a retaining ring.

20. The method of claim 11 wherein the base has more than one shelf to receive the one or more disks.
